(19) United States
(12) Patent Application Publication
(10) Pub. No.: US 2026/0342748 A1
(43) Pub. Date: Oct. 29, 2026

(54) MANAGING IMPACTS OF MANAGEMENT DECISIONS IN AGENTIC AGENT BASED SYSTEMS

(71) Applicant: Dell Products L.P., Round Rock, TX (US)

(72) Inventors: OFIR EZRIELEV, Be'er Sheva (IL); YEHIEL ZOHAR, Sderot (IL); HANNA YEHUDA, Acton, MA (US)

(21) Appl. No.: 19/192,644

(22) Filed: Apr. 29, 2025

(51) Int. Cl. H04L 51/02; G06F 40/10; G06Q 10/0631; H04L 41/0895; H04L 41/40; H04L 51/04

(52) U.S. Cl. CPC H04L 51/02; G06F 40/10; G06Q 10/063112; H04L 41/0895; H04L 41/40; H04L 51/04

(57) ABSTRACT

Methods and systems for managing operation of infrastructure are provided. To manage the infrastructure, agentic agents may be deployed. The deployed agentic agents may be customized prior to deployment. The agentic agents may be managed through a chat interface through which management decisions may be made. A graphical representation based on the agentic agents and management decisions made during a chat session may be displayed to a user during the chat session. The graphical representation may contextualize different portions of the chat session with respect to abilities of the agentic agents to accomplish assigned goals.

### FIELD

Embodiments disclosed herein relate generally to infrastructure. More particularly, embodiments disclosed herein relate to systems and methods to manage infrastructure using agentic agents.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-2B show data flow diagrams illustrating processing and use of data in accordance with an embodiment.

FIGS. 3A-3C show flow diagrams illustrating methods in accordance with an embodiment.

FIG. 4 shows a block diagram illustrating a data processing system in accordance with an embodiment.

### DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of infrastructure. To manage the infrastructure, agentic agents may be deployed and tasked with managing the infrastructure to effectuate the desired intents of users of the infrastructure.

The agentic agents may be customized for different domains. Once customized, users may initiate communications with the agentic agents using a chat interface. The chat interface may be used to convey the intents to the agentic agents. Different agentic agents may be customized to different domains and, therefore, may have access to different types of information, reasoning processes, etc. Accordingly, the agentic agents may generate different responses to chats by the users.

The chat interface may be used to obtain information regarding intents of the user, confirm the intents of the users, and/or align future management activities of the agentic agents with the user intents.

In addition, icons associated with different domains may be represented by each of the agentic agents based on their respective competency. The icons may provide additional information for the user to understand the motivations, responsibilities, etc. for the agentic agents providing the responses.

By doing so, embodiments disclosed herein may improve the likelihood of services provided by infrastructure being deemed to be desirable by the users. Thus, embodiments discussed herein may address, among others, the technical problem of intent and expectation mismatch between users of infrastructure and the managers of the infrastructure.

In an embodiment, a method for managing infrastructure that provides desired computer implemented services is provided. The method may include, during a chat session between a user and agentic agents tasked with managing operation of the infrastructure: generating a graphical representation of: the agentic agents, and impacts on abilities of the agentic agents to accomplish assigned goals due to management decisions made by the user during the chat session; displaying the graphical representation to the user to contextualize at least one portion of the chat session with respect to the impacts on the abilities of the agentic agents to accomplish the assigned goals; obtaining additional user input based on the contextualization of the portion of the chat session; and using the additional user input to manage operation of the agentic agents to provision desired computer implemented services using the agentic agents.

The method may also include identifying impacts on abilities of the agentic agents to accomplish assigned goals due to management decisions made by the user during the chat session.

The agentic agents may be adapted to incorporate the management decisions in action selection processes for managing the operation of the infrastructure.

The management decisions may be portions of the chat session designated by the user.

Generating the graphical representation may include adding first representations of the agentic agents to the graphical representation; adding second representations of the impacts on abilities of the agentic agents to accomplish assigned goals due to management decisions made by the user during the chat session; and positioning the second representations with respect to the first representations to convey associations between the first representations and the second representations.

Displaying the graphical representation may also include identifying a selection of one of the second representations by the user; and adding, based on the selected one of the second representations, a summary based on the management decisions and the goals.

The summary may indicate a portion of at least one of the goals that an agentic agent is impeded in accomplishing by at least one of the management decisions.

Each of agentic agents may be adapted for competency with respect to one logical domain of the logical domains selected from a list consisting of: security; performance; data protection; resource management; health; and sustainability.

Each of agentic agents may be adapted for competency with respect to one system domain of system domains selected from a list consisting of: a data center environment; a telecommunications computing environment; an edge computing environment; a cloud computing environment; a backup computing environment; an artificial intelligence environment; a co-located computing environment; and a storage computing environment.

Each component of components of the infrastructure may be associated with one of the system domains.

In an embodiment, a non-transitory media is provided that may include instructions that when executed by a processor cause the above noted method to be performed.

In an embodiment, a data processing system is provided that may include the non-transitory media and a processor, and may perform the above noted method when the computer-instructions are executed by the processor.

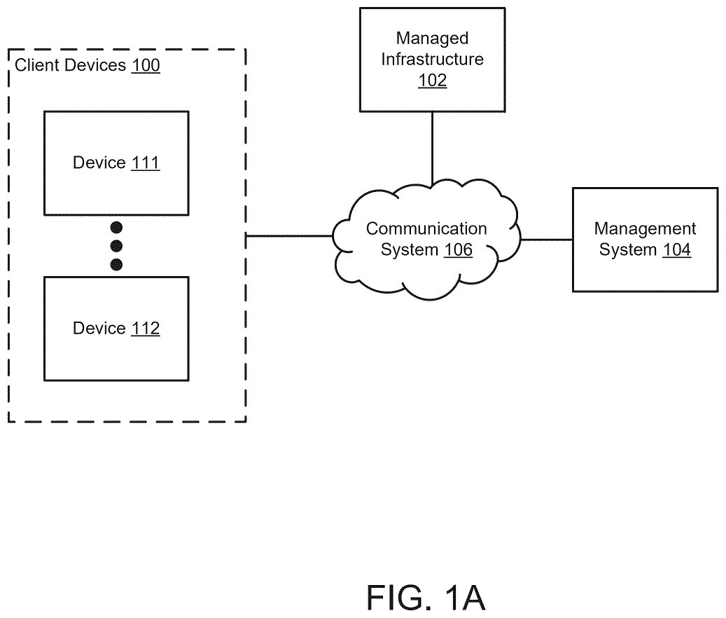

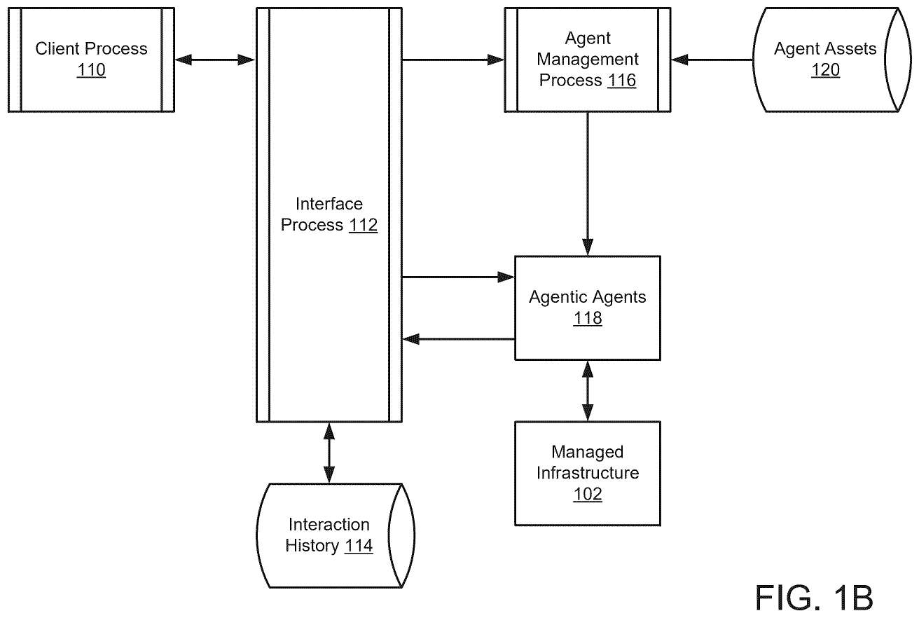

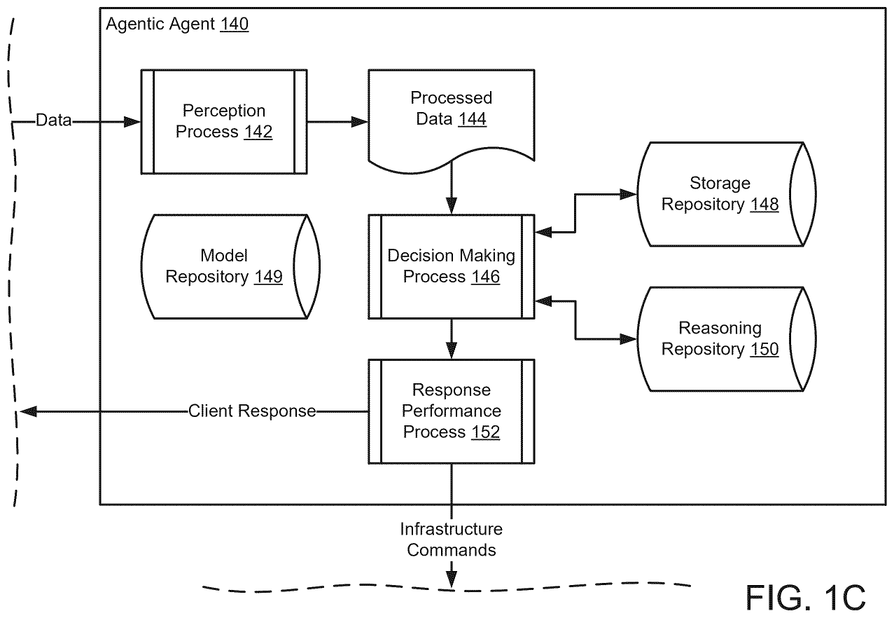

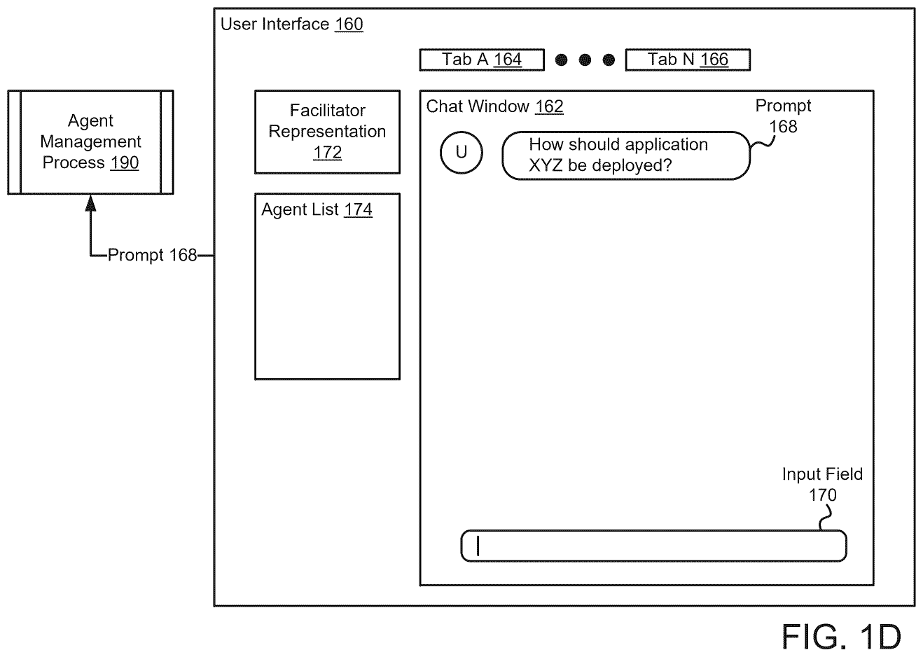

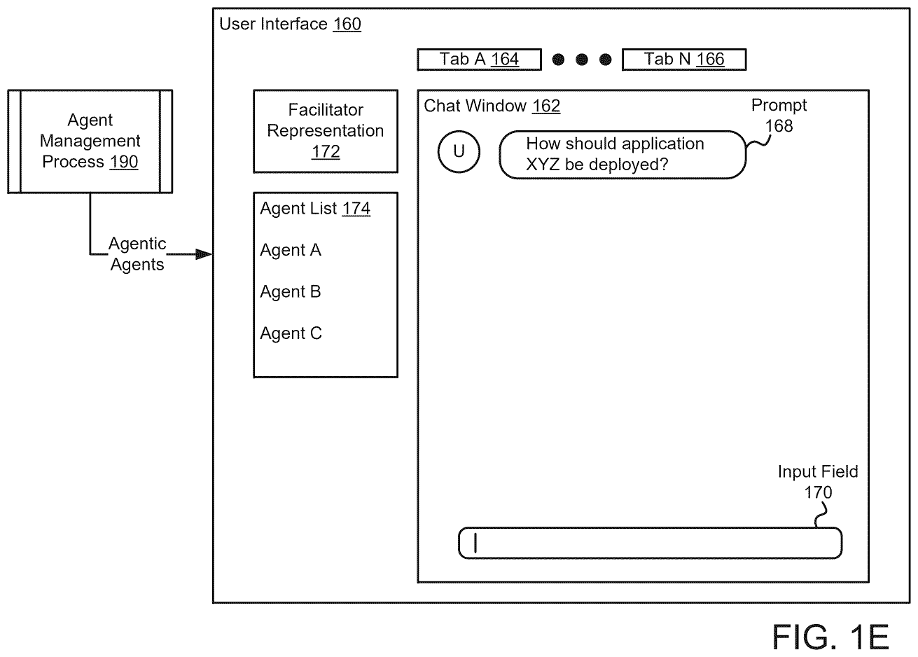

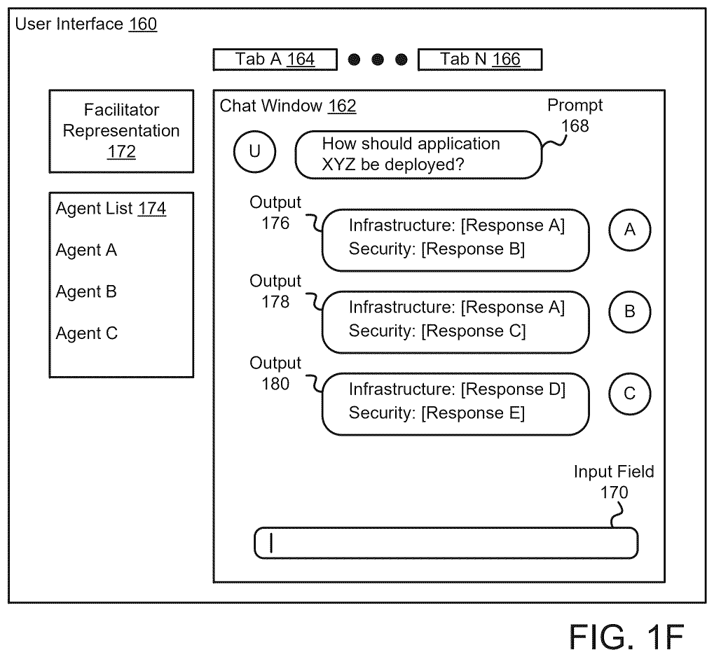

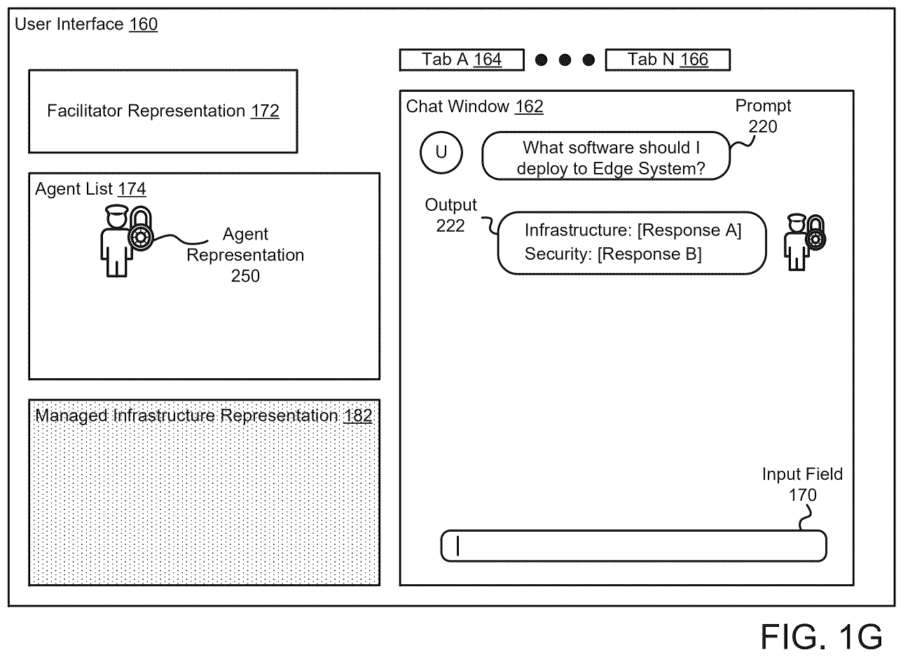

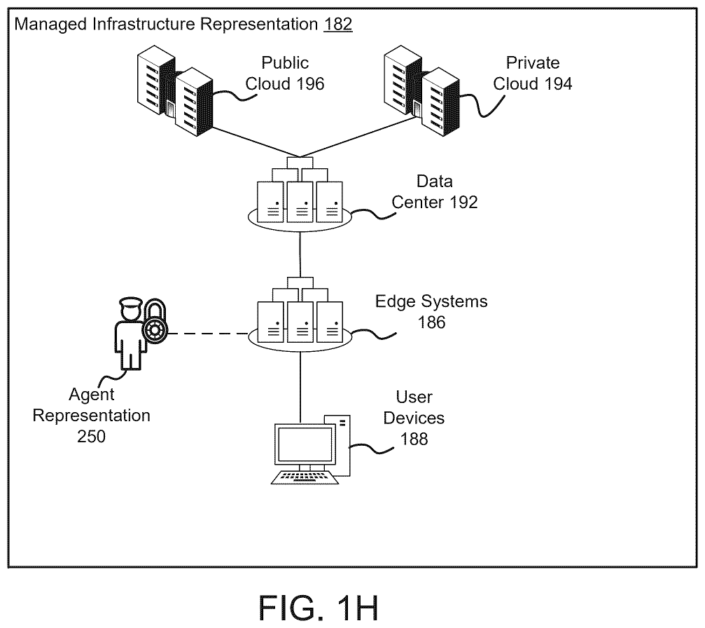

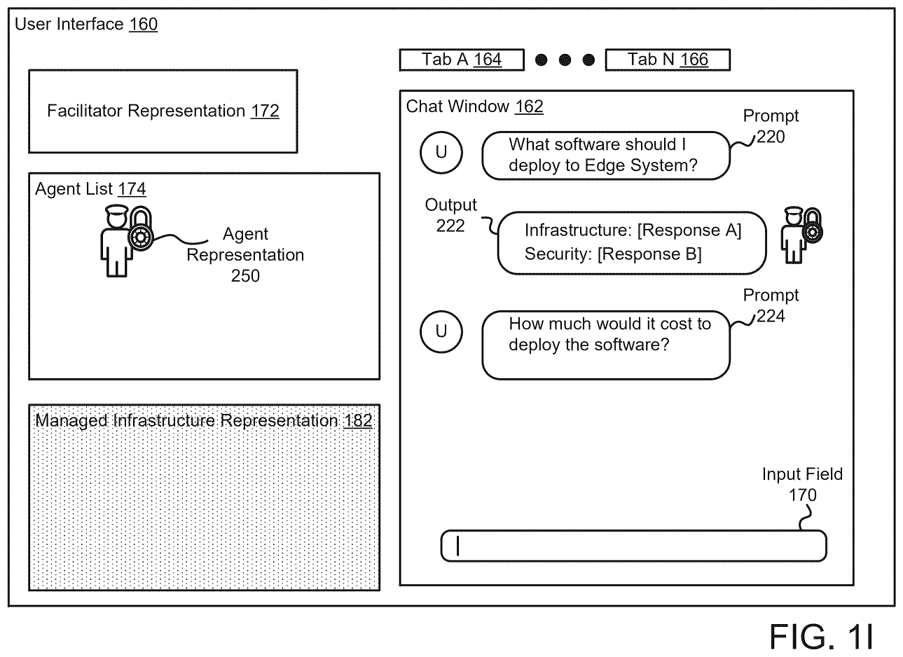

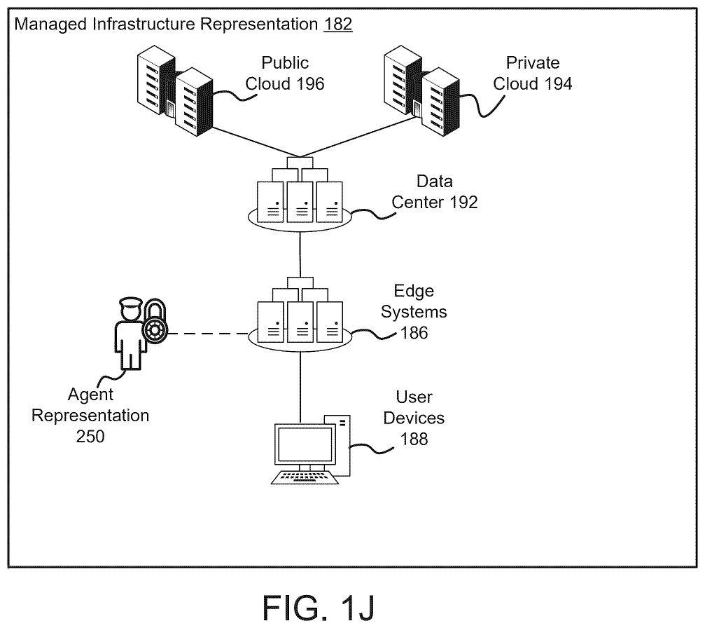

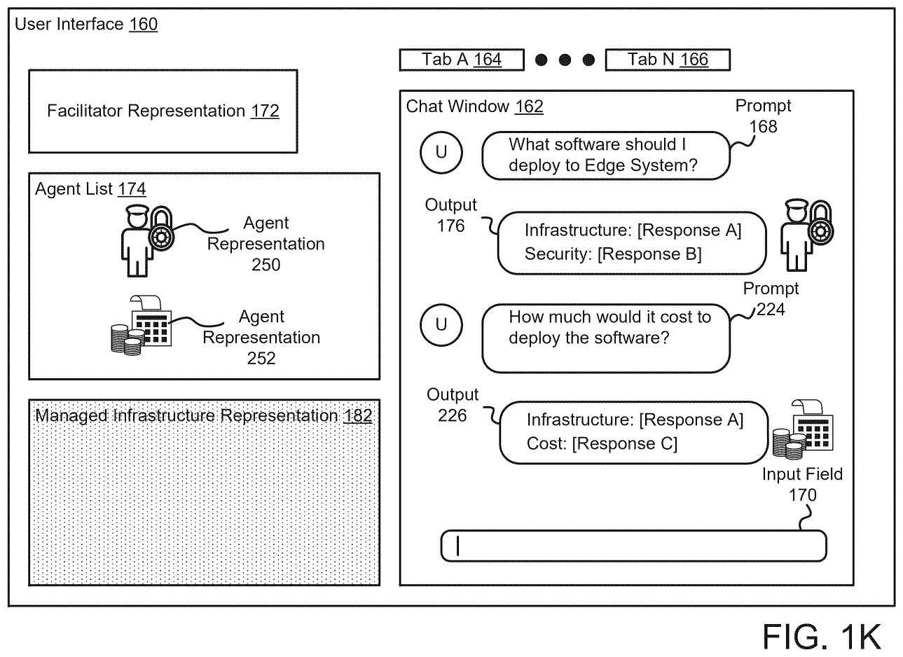

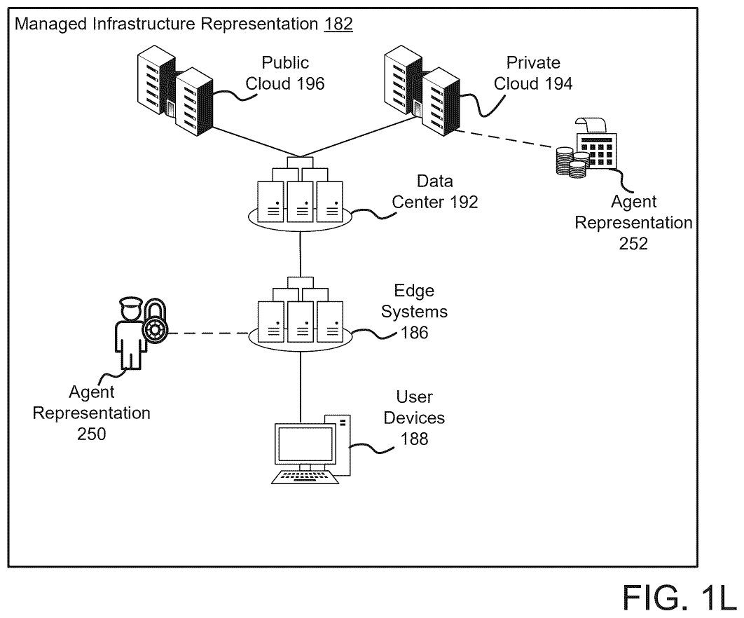

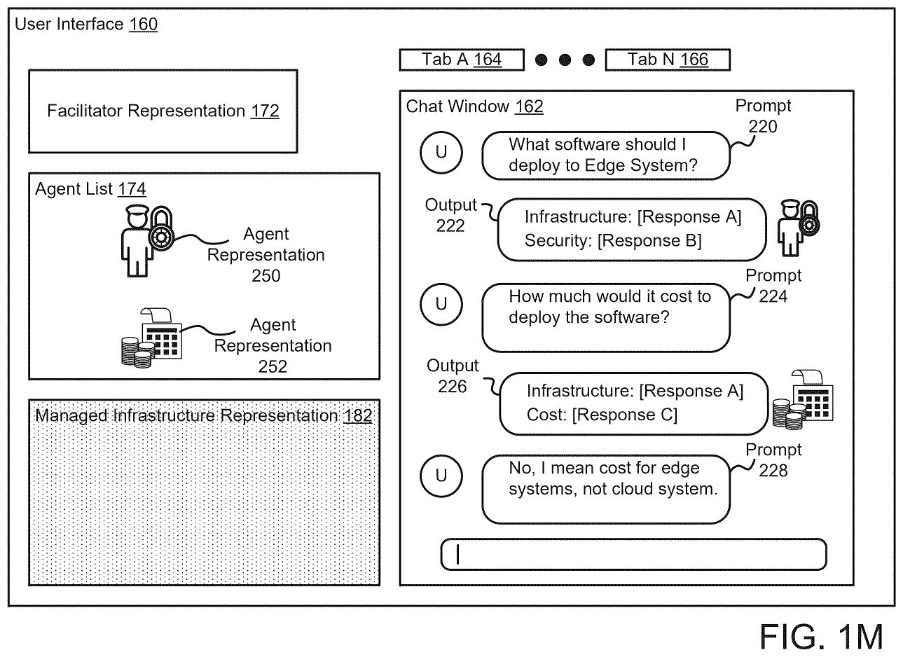

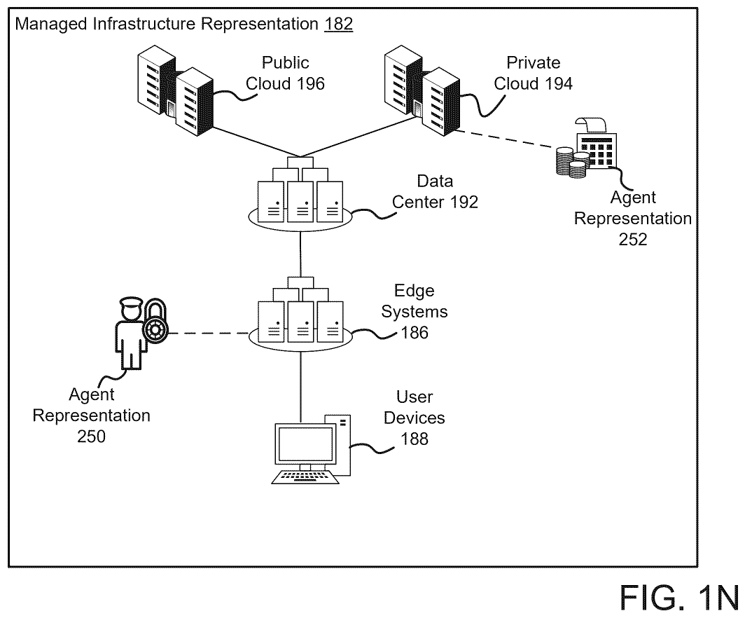

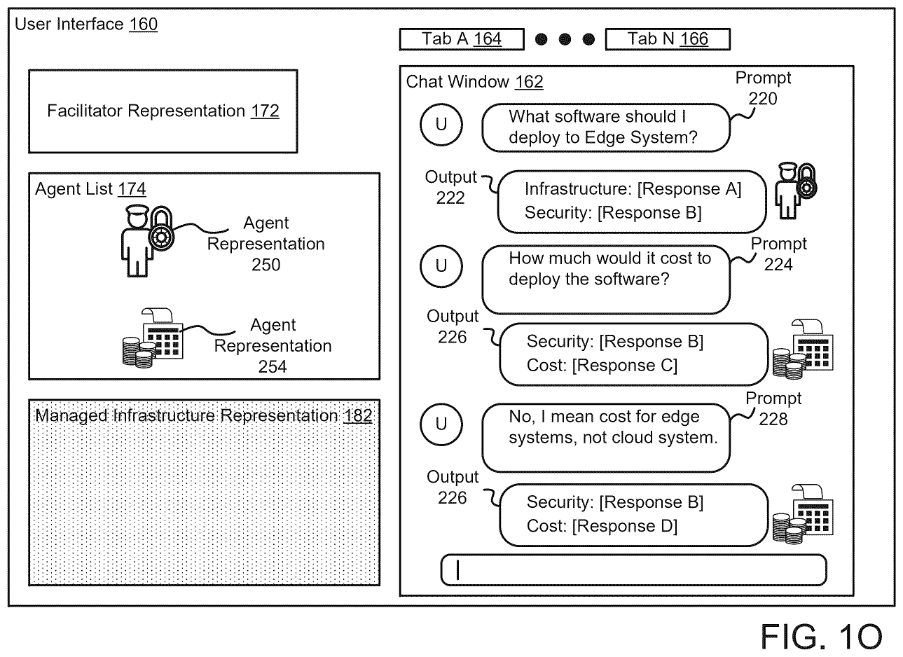

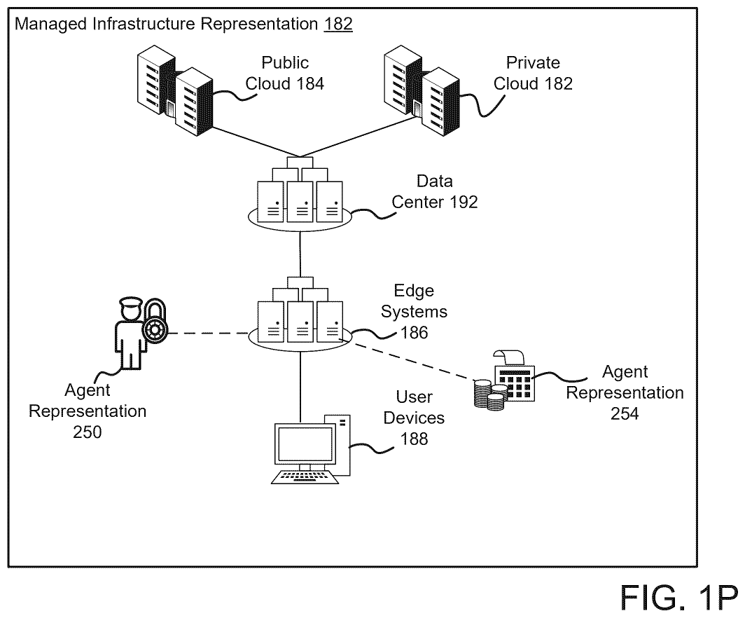

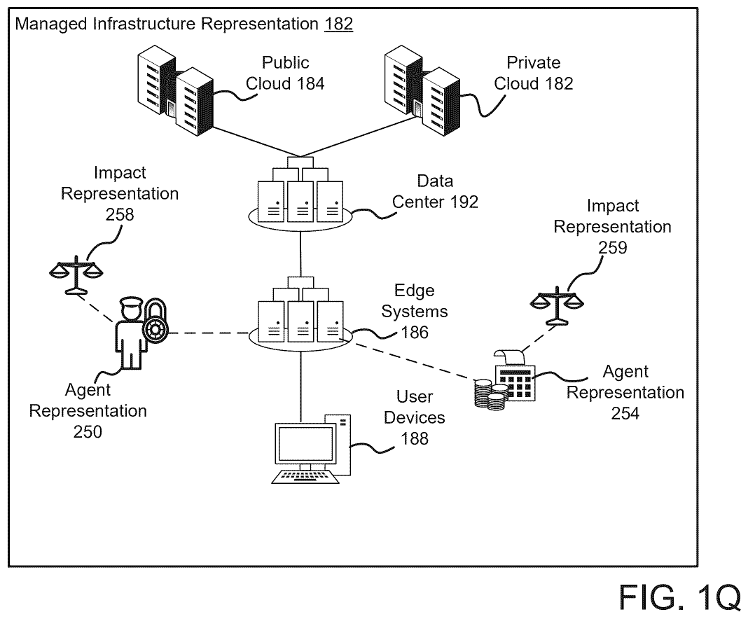

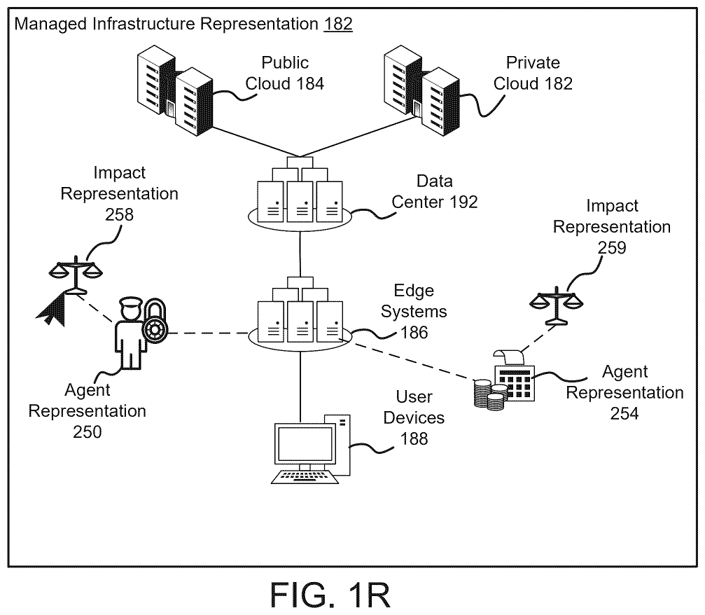

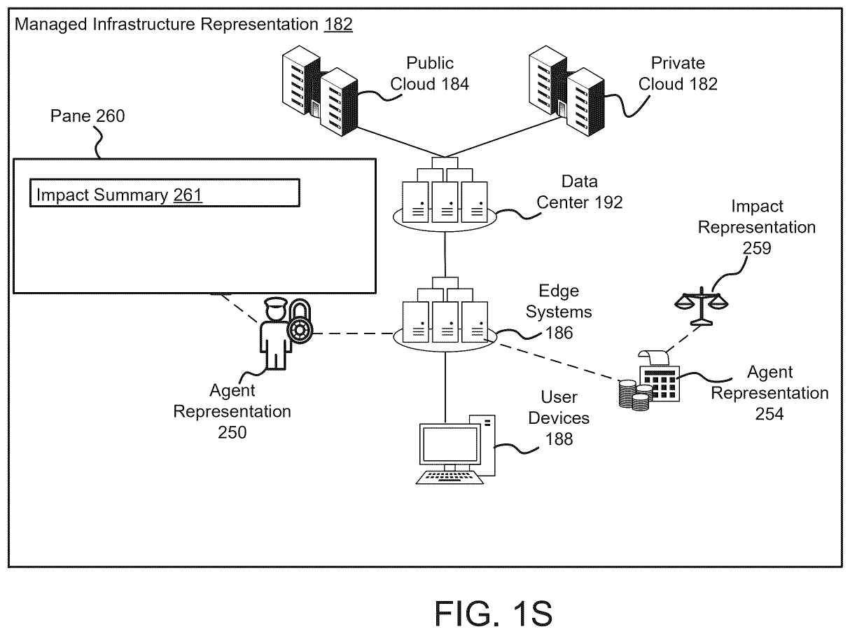

Turning to FIG. 1A, a block diagram of a system in accordance with an embodiment is shown. The system may provide any number and type of computer implemented services.

The computer implemented services may include, for example, database services, data processing services, communications, and/or other types of services. Any of the components of the system of FIG. 1A may provide all, or a portion, of the computer implemented services independently and/or in cooperation with other components of the system.

For the computer implemented services provided by the system of FIG. 1A to be deemed to be desirable by users (e.g., computer programs, persons, etc.) of the computer implemented services, the computer implemented services may need to meet various requirements (e.g., timeliness, accuracy, cost, etc.) and may need to be provided in certain manners (e.g., complete objectives). These requirements and manners may be indicated, for example, by users of the computer implemented services.

To ensure that the computer implemented services meet the requirements and manners of provisioning so that they are (or at least more likely to be) deemed to be desirable, the system of FIG. 1A may configure itself in a corresponding manner. For example, various pieces of software may be deployed, configurations of the software and/or hardware components may be set, various resources of the system may be reserved for contributing to the services, etc.

However, if the aforementioned configuration of the system of FIG. 1A is not successfully completed, then the computer implemented services may be more likely to be deemed to be undesirable. For example, if insufficient resources for providing the computer implemented services are reserved, then the provided computer implemented services may not meet timeliness (e.g., latency) goals. Other issues may impact the computer implemented services if the aforementioned configuration of the system of FIG. 1A is not successfully completed without departing from embodiments disclosed herein.

Further, a mismatch between an intent of the users regarding the computer implemented services and an understanding of the intent by the system of FIG. 1A may also reduce the likelihood of the computer implemented services being deemed to be desirable. For example, if a user only partially conveys an intent by making a tacit statement (e.g., a partial but incomplete statement of intent) regarding the computer implemented services to be provided, then the system may not successfully a corresponding configuration necessary to provide the computer implemented services in a manner that meets that actual intent of the users.

Additionally, if a mismatch between an understanding of the users regarding future operation of the system of FIG. 1A and the actual likely future operation of the system may further reduce the likelihood of the computer implemented services being deemed to be desirable. For example, the users may have limited knowledge regarding how configurations of the system are likely to impact the provided computer implemented services. Consequently, even if informed of a configuration for the system (e.g., in scenarios where users or other persons establish the configuration), the users may incorrectly identify how the computer implemented services will be provided under that configuration (e.g., the users may expect the computer implemented services to meet different requirements and/or be provided in different manners). Accordingly, the actual computer implemented services may be less likely to meet the users' expectations thereby causing the actually provided computer implemented services to be less likely to be deemed to be desirable.

In general, embodiments disclosed herein relate to systems, methods, and devices for improving the likelihood of computer implemented services provided by systems meeting the expectations of requestors of the services (e.g., being deemed to be desirable). To improve the likelihood of the computer implemented services being deemed to be desirable, an agentic agent based framework may be used to manage the operation of the system. The agentic agent framework may facilitate (i) domain customization and deployment of domain customized agentic agents, (ii) chat based interactions between the domain customized agentic agents and users of the system, (iii) user intent identification and confirmation for the computer implemented services, (iv) cooperative analysis and decision making among the agentic agents, and/or (v) management of infrastructure by the domain customized agentic agents.

By doing so, embodiments disclosed herein may improve the likelihood of computer implemented services provided by a system being deemed desirable by the users for which the services are provided. Thus, embodiments disclosed herein may address, among others, the technical problems of (i) misinterpretation of requests and/or intent in distributed system, (ii) limited technical knowledge of users of the system that may preclude (or limit the ability of) the users from making configuration decisions that are likely to effectuate their intent, and (iii) system configuration drift that may preclude (or limit the ability of) the system to provide desirable computer implemented services.

To provide the above noted functionality, the system may include any number of client devices 100, managed infrastructure 102, management system 104, and communication system 106. Each of these components is discussed below.

Client devices 100 may be used by users (e.g., employees of a business, administrators, computer programs hosted by client devices 100, etc.) to manage and/or obtain computer implemented services provided by/from managed infrastructure 102. To do so, client devices 100 may host interfaces usable to communicate with managed infrastructure 102 and/or management system 104. For example, the interfaces may include chat interfaces through which chat sessions managed by management system 104 may be reached by the users. Client devices may include any number of such devices (e.g., 111, 112) used by any number of users.

Managed infrastructure 102 may provide computer implemented services. To provide the computer implemented services, managed infrastructure 102 may host automation frameworks usable to deploy software, manage configurations of software/hardware components, and/or otherwise modify the operation of various portions of managed infrastructure 102. All, or a portion, of the functionality of the automation frameworks may be usable by agentic agents managed by management system 104.

The agentic agents may be tasked with (i) collecting information from managed infrastructure 102 (e.g., state information, telemetry, etc.), (ii) interacting with users via the chat sessions, (iii) inferring intents of the users regarding computer implemented services to be provided by managed infrastructure 102, and (iv) modifying the operation of managed infrastructure 102 over time to attempt to effectuate the inferred intents.

Because the chat sessions may be an incomplete description of the intent of the users, information obtained by the chat sessions from the users may be treated as tacit statements (e.g., partial statements that may not be a complete declaration of an intent, may be in conflict with other tacit statements, etc.). The tacit statements may be used to infer the intent of the user over time (e.g., which may update as additional tacit statements are obtained). The inferred intent of the users may then be used to identify a goal state for operation of managed infrastructure 102. Once identified, the goal state may be used to select actions to be performed to modify the operation of managed infrastructure 102 to align the actual state of managed infrastructure 102 with the goal state (e.g., over time).

As part of inferring of the intents of the users, information regarding the actual state of managed infrastructure 102 may also be taken into account. Thus, changes in the actual state of managed infrastructure 102 (e.g., changes in hardware components, changes in deployed software, changes in configurations, changes in conditions impacting managed infrastructure 102, etc.) may also change the inferred intents of the users.

To identify the actions to be performed, a quantification process regarding the intent may be performed. For example, an objective function may be formed and used to evaluate the impact of performance of different actions to modify the state of managed infrastructure 102. In an example, the objective function may be formed using key performance indicators (e.g., service latency, resiliency to cyberthreats, cost of operation, etc.) from the inferred intents. These key performance indicators may be compared to actual key performance indicators of the distributed system to identify the degree (e.g., which may be quantified by the objective function) to which the intents of the users are being effectuated by managed infrastructure 102.

Overtime, the agentic agents may select actions to perform on the basis of attempting to maximize the degree to which the tents of the users are being effectuated by the actual operation of managed infrastructure 102.

Management system 104 may manage the agentic agents in the system. To manage the agentic agents, management system 104 may (i) customize and deploy domain customized agentic agents to facilitate management of managed infrastructure 102 and (ii) manage chat sessions to facilitate interactions between users and the domain customized agentic agents to (a) infer intents of the users, (b) inform the users of likely impacts for different potential changes in configuration of managed infrastructure 102, and/or (c) otherwise facilitate management of managed infrastructure 102.

When providing their functionality, client devices 100, managed infrastructure 102, and/or management system 104 may perform all, or a portion, of the flows and/or methods shown in FIGS. 1B-3C.

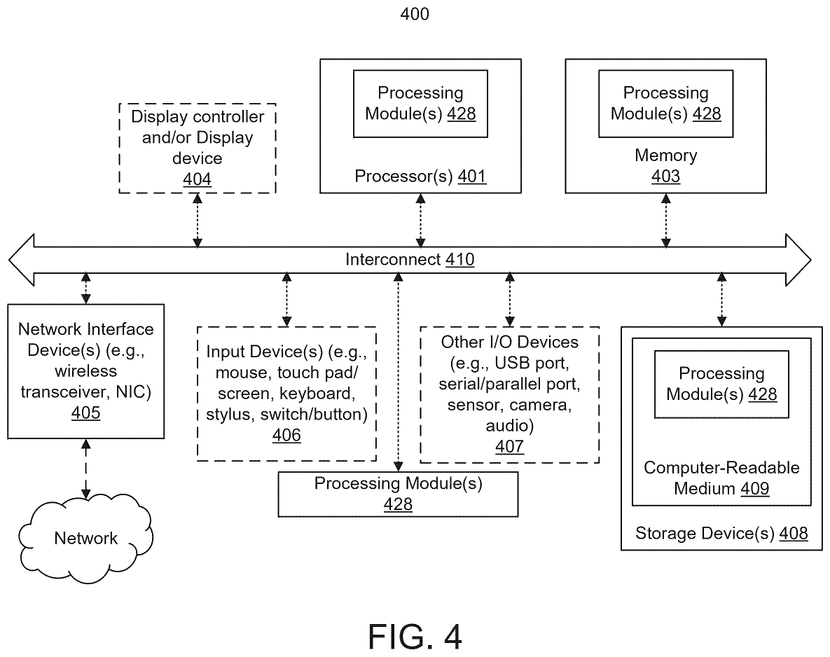

Any of the devices (and/or components thereof) included in the system shown in FIG. 1A may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with a communication system (e.g., 106). In an embodiment, this communication system includes one or more networks that facilitate communication between any number of components (e.g., including others not shown in FIG. 1A). The networks may include wired networks and/or wireless networks (e.g., and/or the Internet). The networks may operate in accordance with any number and types of communication protocols (e.g., such as the internet protocol).

While illustrated in FIG. 1A as including a limited number of specific components, a system in accordance with an embodiment may include fewer, additional, and/or different components than those illustrated therein.

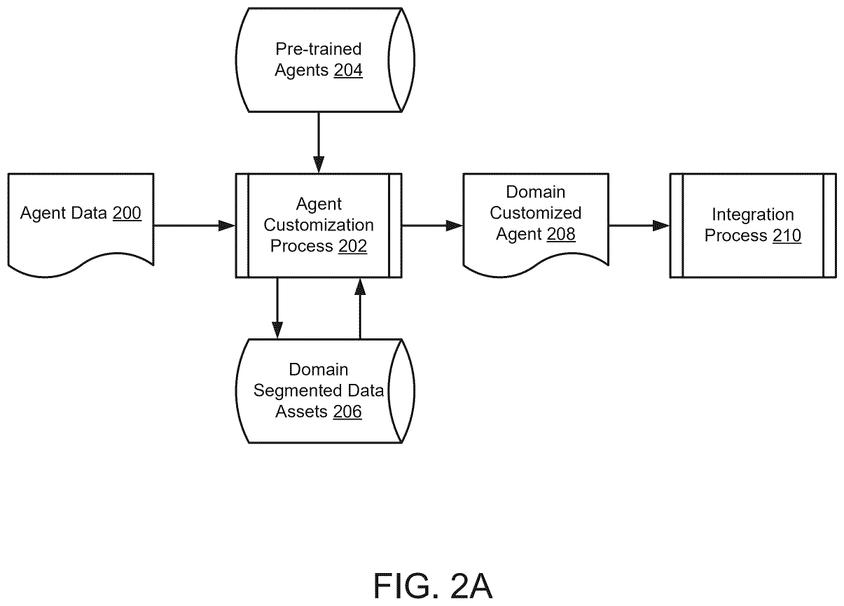

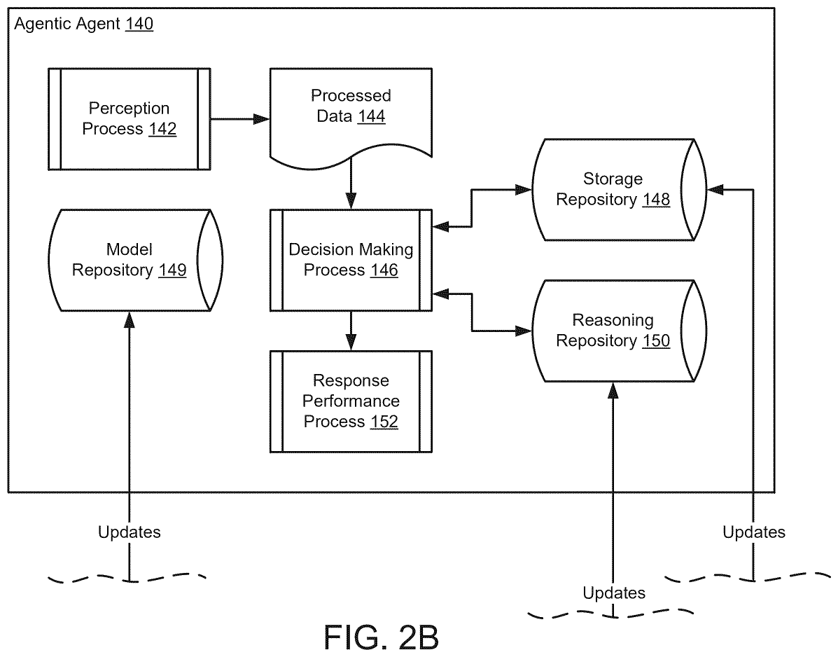

To further clarify embodiments disclosed herein, data flow diagrams in accordance with an embodiment are shown in FIGS. 1B-2B. These data flow diagrams may illustrate how data may be obtained and used within the system of FIG. 1A.

In the data flow diagrams, flows of data and processing of data are illustrated using different sets of shapes. In the context of these data flow diagrams, a first set of shapes (e.g., 144, 200, etc.) is used to represent data structures, a second set of shapes (e.g., 110, 112, etc.) is used to represent processes performed using and/or that generate data, and a third set of shapes (e.g., 114, 120, etc.) is used to represent large scale data structures such as databases.

Turning to FIG. 1B, a first data flow diagram in accordance with an embodiment is shown. The first data flow diagram may illustrate data used in and data processing performed in management of managed infrastructure.

To manage the managed infrastructure, a user may use a client device to perform client process 110. During client process 110, a management request may be sent to the management system. Based on the request, the management system may initiate performance of interface process 112.

During interface process 112, a chat session between the user and the management system may be initiated. The corresponding client process (e.g., 110) may obtain user input and direct it to the chat session managed by interface process 112. Refer to FIGS. 1D-1F for additional information regarding how the chat session may be performed.

During the chat session, information may be conveyed by the user regarding a goal, desire, requirements, and/or other characteristic of computer implemented services to be provided by managed infrastructure 102. The information may be used to identify (i) new agentic agents to be instantiated to assist in accomplishing the intent of the users, and/or (ii) new and/or existing agents to invite to chat session. The agents may be identified, for example, based on a prompt or other information provided by the users. Once identified, the agentic agents may participate in the corresponding chat session.

To instantiate new agentic agents, agent management process 116 may be performed. During agent management process 116, information regarding domains of expertise for an agent may be obtained. The identified domains may be used to discriminate relevant information from agent assets 120. Agent assets 120 may include any type and quantity of information usable to customize an agentic agent for a particular domain. Once obtained, the agentic agent may be customized for the domain (e.g., type of environment in which infrastructure that will be managed by the agent will reside, the particular goal or competency that the agent is desired to have, etc.) and then deployed. Refer to FIGS. 1C and 2A-2B for additional information regarding customization of agentic agents for domains.

The resulting agentic agents may be customized for different operating environments such as, for example, a data center environment; a telecommunications computing environment; an edge computing environment; a cloud computing environment; a backup computing environment; an artificial intelligence environment; a co-located computing environment; and a storage computing environment. The agentic agents may also be customized for different domains of expertise of capabilities such as, for example, security; performance; data protection; resource management; health; and sustainability.

To perform the customization, agent assets 120 may include various types of information usable to customize the operation of, for example, generative artificial intelligence processes performed by, for example, large language models or other types of generative inferencing models used by the agentic agents. For example, agent assets 120 may include documentation for the infrastructure, software hosted by the infrastructure, testing performed for the infrastructure, support tickets for the infrastructure and corresponding resolution processes performed to address the issued indicated by the support tickets, telemetry data for operation of the infrastructure (and/or simulations of the infrastructure, such as digital twins), logs of operation of the infrastructure, etc.

The content of agents assets 120 may be pre-segmented or dynamically segmented with respect to the different domains (e.g., computing environment, competency/concern, etc.) to which the agentic agents may be customized. The content may be segmented with respect to relevancy for these different domains. The segmentation may be performed via any method. For example, a large language model may be used to process different portions of the content and classify it with respect to levels of relevancy, natural language processing and grading rubrics for relevancy may be used, subject matter experts may segment it, etc.

During the performance of interface process 112, information regarding the chat session may be stored in interaction history 114. The information may be used, for example, to document tacit statements made by the users. The tacit statements may be subsequently used to derive intents of the users, and select various management actions for performance to update the operation of managed infrastructure 102 over time. Thus, the operation of managed infrastructure 102 may be more likely to be aligned with the intents of the users and thereby provide computer implemented services that are more likely to be deemed to be desirable by the users.

Turning to FIG. 1C, a second data flow diagram in accordance with an embodiment is shown. The second data flow diagram may illustrate data used in and data processing performed in operation of agentic agents deployed in the system of FIG. 1A.

During operation, agentic agents may include various components that facilitate autonomy and decision making to manage various aspects of the operation of managed infrastructure. For example, an agentic agent may include tool layers that facilitate access and use of external entities to obtain information and drive external processes, reasoning layers to analyze the obtained information using, for example, large language models or other types of generative trained machine learning models, action layers to facilitate interactions between the agentic agents and external entities, and/or other layers.

To implement a tool layer, agentic agent 140 may perform perception process 142. During perception process 142, various types of data may be obtained from remote entities. The data may include, for example, information regarding the state of managed infrastructure, information from other agentic agents, communications of users and/or other entities participating in chat sessions, etc. Once obtained, the obtain data may be processed to obtain processed data 144.

To implement a reasoning layer, agentic agent 140 may perform decision making process 146. As part of decision making process 146, various reasoning algorithms from reasoning repository 150 may be performed, various portions of data may be stored in storage repository 148 for future use and existing information from storage repository 148 may be obtained, various models (e.g., large/small language models) from model repository 149 may be used, and/or other processes may be performed.

For example, a reasoning algorithm such as chain of thought from reasoning repository 150 may be performed. As part of the reasoning algorithm, various calls may be made to the language models from model repository 149 may be made to process various portions of processed data 144 (e.g., which may include text from a chat session, may be used as a prompt). The language models, in turn, may make various calls to data structures stored in storage repository 148 operating as pre-inference information retrieval sources for retrieval augmented generation (RAG). The resulting inferences from the language models may be used to drive the operation of the reasoning model to obtain various outcomes and store various portions of information in storage repository 148 for future use.

To implement an action layer, agentic agent 140 may perform response performance process 152. During response performance process 152, the outcomes obtained from the reasoning process may be used to invoke functionality of various other entities such as to, for example, send responses to chat sessions and modify the operation of the managed infrastructure. For example, when participating in a chat session, text from a user may be processed as a prompt by the agentic agent which may in turn generate a client response and/or initiate performance of an infrastructure command to modify the operation of the managed infrastructure. The infrastructure command may be processed by an automation framework of the managed system, and cause corresponding actions to be performed by the managed infrastructure. For example, the infrastructure command may be to change a configuration setting, remove/add/modify software, disable/enable various hardware components, etc.

Turning to FIG. 1D, a third data flow diagram in accordance with an embodiment is shown. The third data flow diagram may illustrate data used in and data processing performed in chat sessions used to manage the managed infrastructure.

When a client process reaches out to the management system, an agent management process (e.g., 190) may be performed. During the agent management process, a chat session may be initiated to facilitate interactions between users and agentic agents that manage portions of managed infrastructure.

It will be appreciated that the chat session may include various exchanges and storages of information temporally over time between various participants of the chat session. To facilitate understanding of the chat session, a user interface (e.g., 160) may be presented to a user participating in the chat session. User interface 160 may be a graphical user interface usable to represent how the user and other entities are participating in the chat session. User interface 160 may include, for example, tabs (e.g., 164-166), chat window 162, facilitate representation 172, and agent list 174. Each of these components is discussed below.

Tabs 164-166 may be graphical representations of different chat sessions that the user is participating in at any point in time. For example, during a duration of a chat session, a tab may exist. To page through the different chat session, the user may select corresponding ones of the tabs. When so selected, chat window 162, facilitate representation 172 and agent list 174 may be updated to reflect the chat session selected by the user.

Chat window 162 may be a graphical representation of contributions to a chat discussion made by the user and other entities. For example, chat window may include an input field (e.g., 170) through which the user may provide user input. The user input may be treated, for example, as prompt (e.g., 168) or other type of statement for processing.

For example, when a chat session is initially established, the user may enter text which may be processed as a prompt to attempt to identify agentic agents to participate in the chat session. In the context of a prompt such as “How should application XYZ be deployed”, the prompt may be processed using a large language model (or other type of analysis) to identify which agentic agents are likely to positively contribute to a discussion regarding the prompt (e.g., in the context of the managed infrastructure). The aforementioned prompt may result in the identification that new agentic agents should be instantiated due to the domains indicated by the prompt, and identification of existing agentic agents that are to participate in the discussion (e.g., on the basis of relevancy to the domains). As noted above, each customized agentic agent may be customized for a subset of domains (e.g., computing environment, competency, etc.).

Thus, prompt 168 may be processed by agent management process 190 which may in turn instantiate and/or connect various agentic agents to the chat session.

To inform the user of participants in the discussion, facilitate representation 172 may be graphical representation of a facilitator (e.g., an agentic agent, or other type of computerized entity) participating/guiding the discussion.

Likewise, to inform the user of the agentic agents, agent list 174 may include representations of the agentic agents that are participating in the discussion. In the example illustrated in FIG. 1D, no representations are included in agent list 174 because no agentic agents have joined the chat session.

Turning to FIG. 1E, a fourth data flow diagram in accordance with an embodiment is shown. The fourth data flow diagram may illustrate data used in and data processing performed in chat sessions used to manage the managed infrastructure.

Once agentic agents have joined the chat session, as shown in FIG. 1E, identities/representations of the agentic agents may be added to agent list 174. In this example, Agent A, Agent B, and Agent C are used. However, it will be appreciated that icons or other types of graphical elements may be used to convey to the user which agents are participating in the chat session.

Turning to FIG. 1F, a fifth data flow diagram in accordance with an embodiment is shown. The fifth data flow diagram may illustrate data used in and data processing performed in chat sessions used to manage the managed infrastructure.

Once agentic agents have joined the chat session, the agentic agents may independently and/or in cooperation participate in the chat session by, for example, generating output (e.g., 176-180) based on portions of the chat. The agentic agents may do so, for example, using their reasoning logic and language models. The output may be of any type and form. However, as discussed above, each of the agents may be customized for different domains. Consequently, the content of the responses generated by the respective agents may be different and aligned with the respective competency domains of the respective agents.

The chat session may then progress with the user adding addition information via input field 170 to the chat and the agentic agents participating in the chat generating corresponding responses.

Overtime, the agentic agents may process the chat to generate proposed tacit statements regarding an intent of the user. These statements may be presented as an output to the user, and the user may confirm, modify, or deny acceptability of the tacit statements. When a tacit statement is confirmed, the confirmed tacit statement may be stored as part of the corpus of knowledge used to infer the intent of the user.

The agentic agents may then act on the inferred intent of the user, as discussed above.

Turning to FIG. 1G, a sixth data flow diagram in accordance with an embodiment is shown. The sixth data flow diagram may illustrate data used in and data processing performed in chat sessions used to manage the managed infrastructure.

To manage the managed infrastructure, a user interface 160 may be similar to the graphical user interface described above in FIGS. 1D-1F, wherein a user is participating in a chat session (e.g., including various exchanges and storages of information temporally over time). User interface 160 may include, for example, tabs (e.g., 164-166), chat window 162, facilitate representation 172, agent list 174, and managed infrastructure representation 182.

As described above, a chat window (e.g., chat window 162) may be a graphical representation of contributions to a chat discussion made by the user and other entities. For example, chat window may include an input field (e.g., 170) through which the user may provide user input. The user input may be treated, for example, as prompt (e.g., 220) or other type of statement for processing. For example, the user may enter text which may be processed as a prompt to attempt to identify agentic agents to participate in the chat session. As shown in FIG. 1G, the user may input a prompt such as “What software should I deploy edge system?” which may be processed (e.g., using a large language model or other type of analysis) to identify which agentic agents are likely to positively contribute to a discussion regarding the prompt.

As a result, the domains indicated by the prompt may be used to identify agentic agents that are competent in those same domains. As noted above, each of the agentic agents may be trained and/or customized to be competent in a subset of domains (e.g., logical domains, and system domains). A graphical representation of the subset of domains may be displayed to a user to thereby allow contextualization of responses (e.g., output 222) generated by the agentic agents participating in the chat session.

Once agentic agents have joined the chat session, as shown in FIG. 1G, representations of the agentic agents may be added to agent list 174. In this example, Agent representation 250 is represented as an icon of a security person and symbol of a lock. The icons used as representations of the agentic agents participating in the chat session may correspond to a competency level regarding logical domains. The logical domains may include a level of competency in, for example, security, performance, data protection, resource management, health, sustainability, and/or any other type of logical domain. Each logical domain may be presented using, for example, different icons pertaining to the respective logical domain. For example, the logical domain of “sustainability” may be illustrated using an icon with a leaf to illustrate the corresponding domain, the logical domain of “resource management” may be illustrated using an icon with a gear to illustrate the corresponding domain of management, etc.

Managed infrastructure representation 182 may include any of the infrastructure managed by the agentic agents that are participating in the chat session. Refer to FIG. 1H for additional information regarding the managed infrastructure representative.

Turning to FIG. 1H, a seventh data flow diagram in accordance with an embodiment is shown. The sixth data flow diagram may illustrate data used in and data processing performed in chat sessions used to manage the managed infrastructure.

As shown in FIG. 1H, managed infrastructure representation 182 may include any type of system domains. System domains may include, for example, a data center (e. data center 192), edge systems (e.g., edge systems 186), user devices (e.g., user devices 188), cloud systems (e.g., public cloud 196, private cloud 194), and/or any other type of system domains. Although illustrated in FIG. 1H as specific system domains represented, it may be appreciated that the managed infrastructure representation may include other types of system domains. For example, the managed infrastructure may include system domains for an artificial intelligence environment, a co-located computing environment, a telecommunications environment, a backup computing environment, and/or any other type of computing environments.

Different portions of infrastructure may be connected to other portions of infrastructure. To illustrate the connections, a solid line may be drawn between the different computing environments. For example, a flow of data used between different system domains may be represented by each solid line drawn between the different domain systems. For example, a flow of data between edge systems 186 and data center 192 may be illustrated by the solid line drawn between the two system domains.

Managed infrastructure representation 182 may illustrate the infrastructure managed by agentic agents that are present during the chat session shown in FIG. 1G. The infrastructure being managed may remain constant as the chat session progresses, however, the representation of the agentic agents may change as more and/or different agentic agents are called into the chat session. The agent agents may be customized for a type of computing environment. For example, agent representation 250 may be positioned next to edge systems 186 with a dashed line between agent representation 250 and edge systems 186 to illustrate a competency of the agentic agent in edge computing environments. For example, agent representation 250 may be competent in managing security for edge computing environments as indicated by the security related icon positioned next to edge systems 186.

Turning to FIG. 1I, an eighth data flow diagram in accordance with an embodiment is shown. The eighth data flow diagram may illustrate data used in and data processing performed in chat sessions used to manage the managed infrastructure.

Once agentic agents have joined the chat session, as shown in FIG. 1I, icons or other types of graphical elements representing the agentic agents may be added to agent list 174. The chat session may then progress with the user adding addition information via input field 170 to the chat. For example, a user may require additional information regarding economics or cost of the different software options presented via output 222 by agent representation 250. Therefore, the user, for example, may input the prompt (e.g., 220) stating “How much would it cost to deploy the software?”.

Based on prompt 224, additional information indicating a new competency domain may be necessary in response to the prompt. For example, based on processing of prompt 224, an agentic agent that is competent in identifying the cost (e.g., competent in economics) may be required in order to generate a sufficient response to the user.

Turning to FIG. 1J, a nineth data flow diagram in accordance with an embodiment is shown. The nineth data flow diagram may illustrate data used in and data processing performed in chat sessions used to manage the managed infrastructure.

Managed infrastructure representation 182 may illustrate the infrastructure managed by agentic agents that are present during the chat session shown in FIG. 1K. As the chat session progresses and agentic agents are instantiated, an evolution of the managed infrastructure representation may occur to illustrate the relationships between logical competencies and system domains of expertise for each respective agent participating in the chat session. In the example illustrated in FIG. 1J, a representation of a single agentic agent (e.g., agent representation 250) is shown because no other agentic agents have joined the chat session at this point in time.

Turning to FIG. 1K, a tenth data flow diagram in accordance with an embodiment is shown. The tenth data flow diagram may illustrate data used in and data processing performed in chat sessions used to manage the managed infrastructure.

As the chat session progresses with the user adding additional information via input field 170 to the chat, more agentic agents may participate in the chat and generate corresponding responses.

Once agentic agents have joined the chat session, as shown in FIG. 1K, icons or other types of graphical elements may be added to agent list 174 and used to convey to the user which agents are participating in the chat session. As shown in FIG. 1K, a second agentic agent (e.g., agent representation 252) may enter the chat session and may participate in the chat session by, for example, generating an output (e.g., 226) based on a user's input (e.g., prompt 224).

Each of the agentic agents may be customized for different domains and as such, the content of the responses generated by the respective agentic agents may be aligned with the respective competency domains. For example, output 226 may be a response generated based on the agentic agent's respective competency domains. For example, the response (e.g., output 226) generated by agent representation 252 may be based on competency in economics (e.g., logical domain of competency) and/or competency in infrastructure (e.g., system domain of competency). Refer to FIG. 2L for additional information regarding the competency of system domain for agent representation 252.

Similarly to agent representation 250, an icon representing the respective competency in logical domains may be used to convey to the user additional information regarding the competency of the respective agentic agent. For example, agent representation 254 may be illustrated as an icon related to economics (e.g., a calculator and some form of currency next to the calculator) to represent competency in economics.

Turning to FIG. 1L, an eleventh data flow diagram in accordance with an embodiment is shown. The eleventh data flow diagram may illustrate data used in and data processing performed in chat sessions used to manage the managed infrastructure.

Managed infrastructure representation 182 may illustrate the infrastructure managed by agentic agents that are present during the chat session shown in FIG. 1K. As the chat session progresses and agentic agents are instantiated, an evolution of the managed infrastructure representation may occur to illustrate the relationships between logical competencies and system domains of expertise for each respective agent participating in the chat session.

Because prompt 224 was not contextualized, the facilitator may call in an agentic agent that is competent in economics but for a cloud environment (e.g., private cloud 194). In the example illustrated in FIG. 1L, agent representation 252 is illustrated next to private cloud 194 to represent an association with respect to the component of the infrastructure in which the agentic agent is competent. By doing so, the response (e.g., output 226 shown in FIG. 1K) provided by the agent (e.g., agent representation 252) may be insufficient for the user's intended computing environment. For example, the agentic agents participating in the chat session at this point in time are not competent in both the logical domain (e.g., economics) and the system domain (e.g., edge system) corresponding to the prompt (224).

Turning to FIG. 1M, a twelfth data flow diagram in accordance with an embodiment is shown. The twelfth data flow diagram may illustrate data used in and data processing performed in chat sessions used to manage the managed infrastructure.

The user may enter text which may be processed as a prompt to attempt to identify an agentic agent that is competent in economics for an edge system environment. In the context of a prompt such as “No, I mean cost for edge systems, not cloud system,”, the prompt may be processed using a large language model (or other type of analysis) to identify which agentic agent is likely to positively contribute to the discussion regarding the prompt for both the logical domain (e.g., economics) and system domain (e.g., edge computing environment).

Turning to FIG. 1N, a thirteenth data flow diagram in accordance with an embodiment is shown. The thirteenth data flow diagram may illustrate data used in and data processing performed in chat sessions used to manage the managed infrastructure.

Managed infrastructure representation 182 may illustrate the infrastructure managed by agentic agents that are present during the chat session shown in FIG. 1M. Since the prompt shown in FIG. 1M has not been processed at that point in time, the agentic agents participating in the chat session (e.g., agent representation 250 and 252) may remain the same as those shown in FIG. 1L. For example, agent representation 250 may be competent in security (e.g. logical domain) for edge computing environment (e.g., edge systems 186) and agent representation 252 may be competent in economics for cloud computing environment (e.g., private cloud 194).

Therefore, no agents capable of addressing the prompt (224) that is competent in the system domain (e.g., for edge computing environments) and the logical domain (e.g., economics) is present in the chat session. For example, the agentic agents (e.g., agent representation 250 and 252) participating in the chat session at this point in time are not competent in both the logical domain (e.g., economics) and the system domain (e.g., edge system) corresponding to the prompt (224).

Turning to FIG. 1O, a fourteenth data flow diagram in accordance with an embodiment is shown. The fourteenth data flow diagram may illustrate data used in and data processing performed in chat sessions used to manage the managed infrastructure.

As a result of prompt 228 being processed (e.g., via a large language model or other type of analysis), a third agentic agent may be instantiated and/or connected to the chat session due to the domains indicated by the prompt.

The facilitator (e.g., an agentic agent, or other type of computerized entity) may call in the third agentic agent to the chat session. Likewise, agent list 174 may be updated to include agent representation 254 to inform the user of the new agentic agent that is participating in the discussion.

Once the third agentic agent (e.g., agent representation 254) has joined the chat session, the third agentic agent may generate an output (e.g., 226) as a response to prompt 228. The output (226) may be customized based on the competency domains of agent representation 254. For example, the content of the response may be based on the logical competency of economics and competency in the system domain of edge systems.

Turning to FIG. 1P, a fifteenth data flow diagram in accordance with an embodiment is shown. The fifteenth data flow diagram may illustrate data used in and data processing performed in chat sessions used to manage the managed infrastructure.

Managed infrastructure representation 182 may illustrate the infrastructure managed by agentic agents that are present during the chat session shown in FIG. 1O. Since the prompt shown in FIG. 1O has been processed at this point in time during the chat session, the third agentic agent (e.g., agent representation 254) may be illustrated in FIG. 1P. Agent representation 254 may be illustrated as an icon related to economics (e.g., a calculator and some form of currency next to the calculator) to represent competency in economics and positioned next to edge systems 186 to represent competency in edge computing environments.

Therefore, the competencies (in both logical domains and system domains) of the agentic agents that may be providing responses to prompts (e.g., input by the user) may be conveyed to the user. Contextualizing the information being provided by the agentic agents may allow the user of the system to trust the responses being provided to the user.

As described above and illustrated in FIGS. 1G-1P, a graphical representation of components of the infrastructure being managed by agentic agents and competency levels (e.g., regarding system domains and logical domains) of the agentic agents may be displayed to the user to contextualize the responses generated by the agentic agents. Therefore, additional user input may be obtained based on the contextualized information and used to manage operation of the agentic agents participating in the chat session and a likelihood of provisioning desired computer implemented services using the agentic agents may be increased.

Turning to FIG. 2A, a sixteenth data flow diagram in accordance with an embodiment is shown. The sixth data flow diagram may illustrate data used in and data processing performed in managing agentic agents.

To manage agentic agents, agentic agents may be instantiated over time in response to occurrences of agent instantiation events. The agent instantiation events may be, for example, (i) identification of infrastructure (that is not managed with agentic agents) to manage, (ii) obtaining of requests regarding services to be provided by managed infrastructure, (iii) changes in managed infrastructure (e.g., which may change an environment type, management needs of the infrastructure, etc.), and/or other type of events that may indicate that agentic agents are to be instantiated to assist in management of infrastructure.

To instantiate an agentic agent, agent customization process 202 may be performed. During agent customization process 202, agent data 200 may be obtained. Agent data 200 may include any type and quantity of information usable to identify domains (e.g., system domain which may relate to the environment in which managed infrastructure resides, logical domain which may relate to a desired competency for the agent, etc.) for the agentic agent. Agent data 200 may be obtained, for example, (i) from users which may provide it via a chat session, (ii) from storage (e.g., different types of infrastructures may be associated with different types of agents and/or different numbers of agents, may be based on historic data, subject matter expert provided information, etc.), and/or via other methods.

For example, when a user initiates a chat session, the user may input free text. The free text may be obtained and used to obtain agent data 200. Any type of analysis process may be used to identify (i) domains for agents, and (ii) numbers of agents.

Once the domains are identified, a base agent may be obtained from pre-trained agents 204. Pre-trained agents 204 may include any number of agentic agents that are pre-trained for different domains. The pre-trained agents 204 may include (i) large language models, (ii) reasoning models, (iii) data sources (e.g., for RAG), and/or other components. These components of the pre-trained agents may be trained/populated generally for the domains of the agentic agent (e.g., compute domain+competency domain such as edge+cost, data center+performance, etc.). To do so, large volumes of training data from large numbers of infrastructure instances may have been collected and used in the training to generalize the capabilities of the agentic agents.

The base agent may be selected by discriminating it using the domains identified from agent data 200. For example, each agentic agent of pre-trained agents 204 may be associated with respective domains, and the associations may be used to discriminate one that best fits the domains for the new agentic agent.

Once the base agent is obtained, the base agent may be customized. To customize the base agent, the large language models, reasoning models, and/or data sources may be updated using a portion of domain segmented data assets 206. The domain segmented data assets may be segmented portions of the information from agent assets 120 for different domains. The segmentation may be used to discriminate relevant portions of the information. The information may be pre-segmented, or dynamically segmented using any segmentation process.

Once discriminated, the portion of the information may be used to, for example, refine the large language models, modify operation of the reasoning models, and/or supplement the data sources. For example, domain segmented data assets 206 may include information not used in creation of pre-trained agents 204. The information may include user specific information such as, for example, policies of an organization to which the user belongs, organization specific test results, organization specific documentation, etc.

The updating of the base agent may result in the creation of domain customized agent 208. The aforementioned agent customization process may be repeated to obtain any number of domain customized agents (e.g., for similar or different domains).

Once obtained, integration process 210 may be performed. During integration process 210, instances of the domain customized agents may be instantiated, the instances may be given authority over corresponding managed infrastructure, and the instances may be made discoverable (e.g., so that they can be identified and brought into chat sessions, a registry or dynamic process may be used for discovery purposes).

Once complete, the instances of the domain customized agents may be brought into chat session and manage infrastructure.

Turning to FIG. 2B, a seventeenth data flow diagram in accordance with an embodiment is shown. The seventh data flow diagram may illustrate data used in and data processing performed in customizing agentic agents for different domains.

To customize the agentic agents, as discussed above, information usable to customize the agentic agents may be obtained. Once obtained, various updates may be made to an agentic agent (e.g., 140).

For example, the information may be used to fine-tune operation of one or more large language models. To do so, training cycles using the information may be performed to update the weights and/or other architectural features of the large language models.

In some embodiments, agentic agents may include task-specific large language models. In those cases, multiple large language models (or small language models or other types of models) may be updated through fine-tuning to provide for task specific domain inferencing.

For example, the agentic agents may be pre-trained to perform generalized (i) monitoring of infrastructure, (ii) planning, (iii) troubleshooting such as root cause analysis and/or remediation of root cause issues, (iv) optimization for particular goals for infrastructure, (v) self-learning over time, (vi) business analysis, (vii) detection of issues, (viii) auditing, (ix) financial analysis such as billing, and/or other tasks. The fine tuning may align the manner in which these tasks are performed with particular domains.

Like updating of the models, similar updating may be performed for the reasoning models stored in reasoning repository 150. Any reasoning model refinement process may be performed to update the reasoning models.

Lastly, data sources used to provide context for the agentic agents may be updated by supplementing them with the domain specific information. For example, RAG repositories stored in storage repository 148 may be supplemented through addition of all, or a portion, of the domain specific information and/or derived information from the domain specific information.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

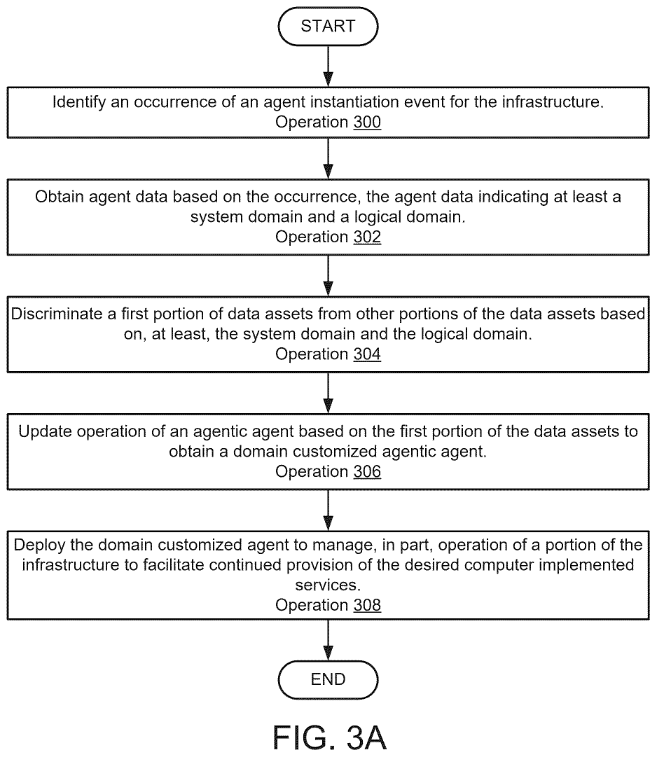

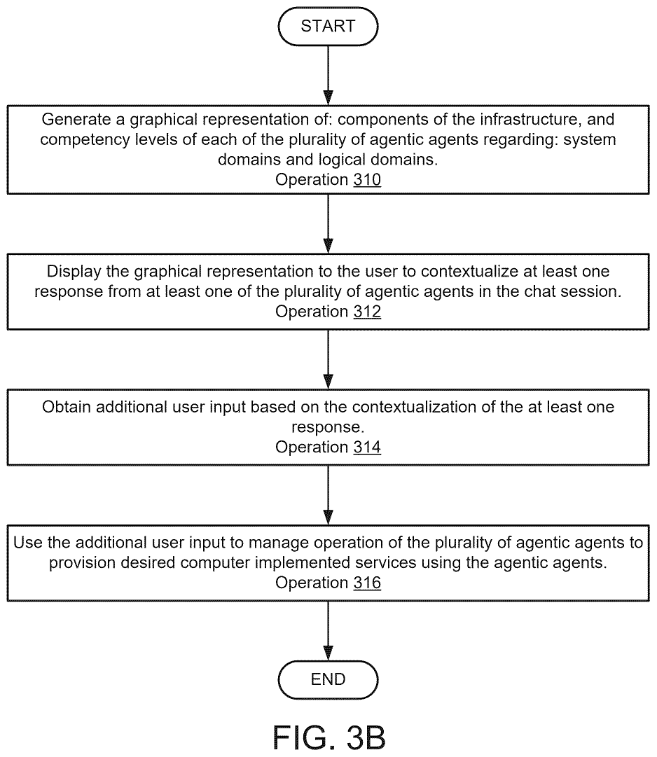

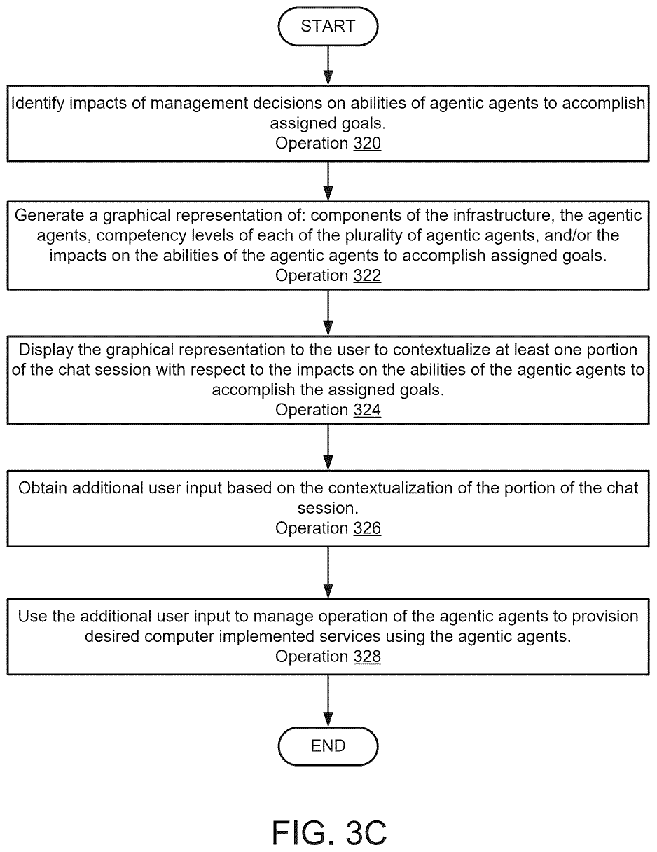

As discussed above, the components of the system shown in FIG. 1A may perform various methods to manage operation of infrastructure. FIGS. 3A-3B illustrates a method that may be performed by the components of the system of FIG. 1A. In the diagram discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing infrastructure using agentic agents in accordance with an embodiment is shown. The method may be performed by any of the components of FIG. 1A, and/or other entities without departing from embodiments disclosed herein.

At operation 300, an occurrence of an agent instantiation event for the infrastructure is identified. The agent instantiation event may be, for example, a management request from a client with respect to the portion of the infrastructure. The request may be obtained by receiving it from the client, reading it from storage, generating it, and/or obtaining it via other process.

At operation 302, agent data based on the occurrence is obtained. The agent data may indicate at least a system domain and a logical domain. The agent data may be obtained by reading it from storage, receiving it from another device, generating it (e.g., by processing a prompt or other information from the client or other entity), and/or via other processes.

The system domain may be a type of computing environment in which portion of infrastructure to be managed is located. The system domain may be one selected from a list consisting of: a data center environment; a telecommunications computing environment; an edge computing environment; a cloud computing environment; a backup computing environment; an artificial intelligence environment; a co-located computing environment; and a storage computing environment.

The logical domain may be a management factor (e.g., a domain of competency) for the portion of the infrastructure. The management factor may be one selected from a list consisting of: security; performance; data protection; resource management; health; and sustainability.

At operation 304, a first portion of data assets from other portions of the data assets is discriminated based on, at least, the system domain and the logical domain. The first portion of the data assets may be discriminated by, for example, using associations between different data assets and the system/logical domains (e.g., the domains may be used as keys to fine the first portion of the data assets), by classifying the data assets with respect to the domains, and/or via other processes.

The data assets may include, for example, documentation regarding the infrastructure, hosted software, support tickets and corresponding resolutions, telemetry from the infrastructure, logs of operation of the infrastructure, client specific information (e.g., internal policies, taxonomies, etc.), and/or other types of data assets that may be used to refine operation of an agentic agent.

At operation 306, operation of an agentic agent is updated based on the first portion of the data assets to obtain a domain customized agentic agent. The agentic agent may be updated by performing fine tuning on language models of the agentic agent, updating reasoning models of the agentic agent, populating RAG data sources of the agentic agent, and/or otherwise using the first portion of the data assets to customize the agentic agent to particular domains.

At operation 308, the domain customized agent is deployed to manage, in part, operation of a portion of the infrastructure to facilitate continued provision of the desired computer implemented services. The domain customized agent may be deployed by, for example, instantiating an instance of the domain customized agent; operably connecting the instance to a control plane for the portion of the infrastructure to facilitate modification of the operation of the portion of the infrastructure by the instance; and placing the instance in a discoverable state by a facilitator.

The facilitator may be adapted to establish chat based interface sessions for clients (e.g., users) with authority to manage the operation of the portion of the infrastructure and selectively integrate domain customized agents into the established chat based interface sessions. For example, based on a prompt received from a client during a chat based interface session, the facilitator may identify agentic agents that may contribute to a discussion to address the client's prompting.

The facilitator may also be adapted to moderate conversation between the clients and the selectively integrated domain customized agents in the established chat based interface sessions to identify intents of the clients with respect to the operation of the portion of the infrastructure and vest authority in the domain customized agents to make changes to the operation of the portion of the infrastructure based on the intents.

The method may end following operation 308.

Turning to FIG. 3B, a second flow diagram illustrating a method for managing infrastructure using agentic agents in accordance with an embodiment is shown. The method may be performed by any of the components of FIG. 1A, and/or other entities without departing from embodiments disclosed herein.

At operation 310, a graphical representation may be generated. The graphical representation may include: components of the infrastructure, and competency levels of each of the plurality of agentic agents regarding: system domains and logical domains. The graphical representation may be generated by processing a prompt or other information input by a client or other entity, and/or via other processes.

At operation 312, the graphical representation may be displayed to the user to contextualize at least one response from at least one of the plurality of agentic agents in the chat session. The graphical representation may be displayed to the user by reading it from storage, receiving it from another device, and/or via other processes. For example, the graphical representation may be displayed to the user by using icons and/or other types of illustrations representing the logical domains for each respective agentic agent, and/or the components of the infrastructure based on the system domains for each of the respective agentic agents.

At operation 314, additional user input may be obtained. The additional user input may be obtained based on the contextualization of the at least one response. The additional user input may be obtained by receiving it from the client (e.g., user participating in the chat session), receiving it from another device, and/or via other processes.

At operation 316, the additional user input may be used to manage operation of the plurality of agentic agents to provision desired computer implemented services using the agentic agents. The additional user input may be used to drive operation of language models of the agentic agents to generate output. The output may be used to respond to prompts or other statements made by users or other entities, to modify operation of infrastructure used to provide the desired computer implemented services, and/or for other purposes. For example, the output may be used to select new configuration settings for software/hardware, deploy/remove software, and/or otherwise change a manner of operation of the infrastructure.

The method may end following operation 316.

The method may also include making an identification that the plurality of agentic agents lack a sufficient competency level in the system domains or the logical domains to address at least one request from the user, and/or any other methods. The identification that the plurality of agentic agents lack the sufficient competency levels in the system domains or the logical domains may be made by (i) receiving user input indicating disagreement with the response provided by agentic agents currently participating in the chat session, (ii) receiving additional user input that indicates an update to a competency level (e.g., regarding logical domain and/or system domain), and/or (iii) by any other methods.

Based on the identification: the method may include: (i) adding an additional agentic agent to the chat session, and (ii) updating the graphical representation based on the additional agentic agent to facilitate contextualization of responses in the chat session generated by the additional agentic agent. The additional agentic agent may be added to the chat session by identifying at least one of the plurality of agentic agents that is sufficiently competent in the system domain and/or the logical domain to address the at least one request and adding the identified agentic agent that is competent to the chat session.

The method may end following operation 316.

Turning to FIG. 3C, a third flow diagram illustrating a method for managing infrastructure using agentic agents in accordance with an embodiment is shown. The method may be performed by any of the components of FIG. 1A, and/or other entities without departing from embodiments disclosed herein.

In addition to contextualizing responses of agentic agents or other portions of chat sessions using representations of infrastructures and agents, the portions of the chat session may be further contextualized with respect to how management decisions made during the chat sessions are likely to impact abilities of the agentic agents to accomplish assigned goals. Due to the different domains to which the agentic agents are customized, different agentic agents may be assigned different goals and different management decisions may impact the abilities of these different goals differently.

However, in conversational interfaces such as chat, these impacts of the management decisions made during the discussion may not be immediately convey to the user. For example, contributions from the respective agentic agents may be distributed over the chat session and may not immediately convey impacts of management decisions to the user. Thus, if a user designates a portion of a chat session as being a management decisions, the user may need to review the chat session in detail and made deductive/inferential leaps to determine how the management decisions are likely to impact the abilities of the agentic agents to accomplish their assigned goals (e.g., may relate to different logical domains, such as cost, security, etc.). To help the user contextualize different portions of the chat session (e.g., with respect to impacts to the agentic agents), a graphical representation may be used as an adjunct to the chat session, as discussed with respect to FIGS. 1G-1P.

At operation 320, impacts of management decisions on abilities of the agentic agents to accomplish assigned goals may be identified. The impacts may be identified by, for example, prompting language models of the agentic agents to describe how such management decisions are likely to impact the agentic agent's assigned goals, to attempt to grade or otherwise quantify the impact on a scale, to provide examples of likely outcomes of the management decisions that are contrary to the assigned goals, etc. Any of the aforementioned information may be used to quantify a magnitude of the impact on the ability of the agent to accomplish assigned goals.

In an embodiment, the language models may be prompted using a discretized scale in quantifying the impact. The discretized scale may include bucketized descriptions such as: very positive (e.g., the management decision(s) significantly helps prioritize one or more of the agentic agents goals), somewhat positive (e.g., the management decision(s) moderately helps prioritize one or more of the agentic agents goals), neutral (e.g., the management decision(s) does not help or hinder one or more of the agentic agent's goals), somewhat negative (e.g., the management decision(s) moderately deprioritize one or more of the agentic agents goals), and very negative (e.g., the management decision(s) significantly deprioritize one or more of the agentic agents goals).

At operation 322, a graphical representation of components of the infrastructure, the agentic agents (e.g., participating in the chat session), competency levels of each of the plurality of agentic agents, and/or impacts on the abilities of the agentic agents to accomplish the assigned goals. The graphical representation may be generated by, for example, populating a template, which may result in a graphical representation similar to those illustrated in FIGS. 1Q-1S.

Turning to FIG. 1Q, a sixteenth data flow diagram in accordance with an embodiment is shown. The sixteenth data flow diagram may illustrate data used in and data processing performed in chat sessions used to manage the managed infrastructure.

The diagram shown in FIG. 1Q may be similar to that shown in FIG. 1P. However, now consider a scenario where, in a chat session, a user designates a portion of the chat session as a management decisions to be implemented by the agentic agents. The now designated portion of the chat session may require the agentic agents to take into account new information in making management decisions that might make it more difficult for the agentic agents to accomplish a goal.

For example, consider a scenario where a portion of a chat session species that security software hosted by edge systems 186 is to be allocated fewer resources. When managing the operation of the infrastructure, both of the agentic agents represented by agent representations 250 and 254 may be impacted by the management decision. For example, agent representation 254 may represent a cost efficiency agent. Reducing the resource allocation (and actions to accomplish that) may be aligned with the agent's goal of reducing cost. In contrast, agent representation 250 may be a security agent. Reducing the resource allocation for the security software (and actions to accomplish that) may not be aligned with the agent's goal of securing edge systems 186. Consequently, this management decisions may have different impacts on these agents, and it may not be clear from the chat session that these impacts are likely to occur based on the user's designation of the portion of the chat session as a management decision.

To contextualize the chat session with these impacts, impact representations (e.g., 258, 259) may be added to managed infrastructure representations 182. The impact representations may be graphical elements indicating a level of impact that a management decision has on abilities corresponding agentic agents to accomplish the goals. The graphical elements may be scaled, colored, and/or may otherwise be adjusted to convey a magnitude of the impact on the agentic agent's ability to accomplish assigned goals.

For example, in FIG. 1Q, scales are used to represent the impact. The scale may be drawn to indicate the impact (e.g., one side or the other being lower to indicate higher impact). Consequently, when a user designates a portion of the chat session as a management decision, the impact representations may contextualize the portion of the chat session with respect to impacts on the abilities of the agentic agents to accomplish assigned goals. This information may enable the user to consider whether the impact is aligned with an expected impact that the user had in mind when making the designation for the portion of the chat session.

Returning to the discussion of FIG. 3C, once the graphical representation is generated, the graphical representation may be used to contextualize portions of a chat session for a user with respect to the impacts.

At operation 324, the graphical representation may be displayed to the user to contextualize at least one portion of the chat session with respect to impacts on the abilities of the agentic agents to accomplish the assigned goals. While displayed, a user may select impact representations to review summaries of the impacts.

Turning to FIG. 1R, a seventeenth data flow diagram in accordance with an embodiment is shown. The seventeenth data flow diagram may illustrate data used in and data processing performed in chat sessions used to manage the managed infrastructure.

While managed infrastructure representation 182 is displayed to a user, the user may select (e.g., using a cursor) or otherwise indicate that additional information for impact representation 258 is desired to be reviewed.

Turning to FIG. 1S, an eighteenth data flow diagram in accordance with an embodiment is shown. The eighteenth data flow diagram may illustrate data used in and data processing performed in chat sessions used to manage the managed infrastructure.

When impact representation 258 is selected, pane 260 may be added to managed infrastructure representation 182 and populated with information regarding the impacts. For example, pane 260 may be populated with a summary of the impacts. The summary may be generated by prompting a language model of the impacted agentic agent.

Returning to the discussion of FIG. 3C, at operation 326, additional input based on the contextualization of the portion of the chat may be obtained from the user. The additional input may be obtained by receiving additional user input. The additional user input may be a modification to the management decision, a confirmation of the management decision, etc.

At operation 328, the additional user input may be used to manage operation of the agentic agents to provision desired computer implemented services using the agentic agents. The additional user input may be used as discussed with respect to operation 316. For example, the agentic agents may be instructed to follow the management decision (or a modified version obtained in operation 326.

The method may end following operation 328.

Thus, via the method shown in FIGS. 3A-3C, embodiments disclosed herein may facilitate management of infrastructure in an automated manner through conversational inferring of intents by domain customized agentic agents.

Embodiments disclosed herein may be implemented with one or more computing devices. Turning to FIG. 4, a block diagram illustrating an example of a data processing system (e.g., a computing device) in accordance with an embodiment is shown.

For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processors can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing infrastructure that provides desired computer implemented services, the method comprising:
during a chat session between a user and agentic agents tasked with managing operation of the infrastructure:
generating a graphical representation of:
the agentic agents, and
impacts on abilities of the agentic agents to accomplish assigned goals due to management decisions made by the user during the chat session;
displaying the graphical representation to the user to contextualize at least one portion of the chat session with respect to the impacts on the abilities of the agentic agents to accomplish the assigned goals;
obtaining additional user input based on the contextualization of the portion of the chat session; and
using the additional user input to manage operation of the agentic agents to provision desired computer implemented services using the agentic agents.

2. The method of claim 1, further comprising:
identifying impacts on abilities of the agentic agents to accomplish assigned goals due to management decisions made by the user during the chat session.

3. The method of claim 2, wherein the agentic agents are adapted to incorporate the management decisions in action selection processes for managing the operation of the infrastructure.

4. The method of claim 1, wherein the management decisions are portions of the chat session designated by the user.

5. The method of claim 1, wherein generating the graphical representation comprises:
adding first representations of the agentic agents to the graphical representation;
adding second representations of the impacts on abilities of the agentic agents to accomplish assigned goals due to management decisions made by the user during the chat session; and
positioning the second representations with respect to the first representations to convey associations between the first representations and the second representations.

6. The method of claim 5, wherein displaying the graphical representation further comprises:
identifying a selection of one of the second representations by the user; and
adding, based on the selected one of the second representations, a summary based on the management decisions and the goals.

7. The method of claim 6, wherein the summary indicates a portion of at least one of the goals that an agentic agent is impeded in accomplishing by at least one of the management decisions.

8. The method of claim 1, wherein each of agentic agents is adapted for competency with respect to one logical domain of the logical domains selected from a list consisting of:
security;
performance;
data protection;
resource management;
health; and
sustainability.

9. The method of claim 1, wherein each of agentic agents is adapted for competency with respect to one system domain of system domains selected from a list consisting of:
a data center environment;
a telecommunications computing environment;
an edge computing environment;
a cloud computing environment;
a backup computing environment;
an artificial intelligence environment;
a co-located computing environment; and
a storage computing environment.

10. The method of claim 9, wherein each component of components of the infrastructure are associated with one of the system domains.

11. A non-transitory machine-readable medium having instructions stored therein, which when executed by a processor, cause operations for managing infrastructure that provides desired computer implemented services to be performed, the operations comprising:
during a chat session between a user and agentic agents tasked with managing operation of the infrastructure:
generating a graphical representation of:
the agentic agents, and
impacts on abilities of the agentic agents to accomplish assigned goals due to management decisions made by the user during the chat session;
displaying the graphical representation to the user to contextualize at least one portion of the chat session with respect to the impacts on the abilities of the agentic agents to accomplish the assigned goals;
obtaining additional user input based on the contextualization of the portion of the chat session; and
using the additional user input to manage operation of the agentic agents to provision desired computer implemented services using the agentic agents.

12. The non-transitory machine-readable medium of claim 11, wherein the operations further comprise:
identifying impacts on abilities of the agentic agents to accomplish assigned goals due to management decisions made by the user during the chat session.

13. The non-transitory machine-readable medium of claim 12, wherein the agentic agents are adapted to incorporate the management decisions in action selection processes for managing the operation of the infrastructure.

14. The non-transitory machine-readable medium of claim 11, wherein the management decisions are portions of the chat session designated by the user.

15. The non-transitory machine-readable medium of claim 11, wherein generating the graphical representation comprises:
adding first representations of the agentic agents to the graphical representation;
adding second representations of the impacts on abilities of the agentic agents to accomplish assigned goals due to management decisions made by the user during the chat session; and
positioning the second representations with respect to the first representations to convey associations between the first representations and the second representations.

16. A system, comprising:
a processor; and
a memory coupled to the processor to store instructions, which when executed by the processor, cause operation for managing infrastructure that provides desired computer implemented services to be performed, the operations comprising:
during a chat session between a user and agentic agents tasked with managing operation of the infrastructure:
generating a graphical representation of:
the agentic agents, and
impacts on abilities of the agentic agents to accomplish assigned goals due to management decisions made by the user during the chat session;
displaying the graphical representation to the user to contextualize at least one portion of the chat session with respect to the impacts on the abilities of the agentic agents to accomplish the assigned goals;
obtaining additional user input based on the contextualization of the portion of the chat session; and
using the additional user input to manage operation of the agentic agents to provision desired computer implemented services using the agentic agents.

17. The system of claim 16, wherein the operations further comprise:
identifying impacts on abilities of the agentic agents to accomplish assigned goals due to management decisions made by the user during the chat session.

18. The system of claim 17, wherein the agentic agents are adapted to incorporate the management decisions in action selection processes for managing the operation of the infrastructure.

19. The system of claim 16, wherein the management decisions are portions of the chat session designated by the user.

20. The system of claim 16, wherein generating the graphical representation comprises:
adding first representations of the agentic agents to the graphical representation;
adding second representations of the impacts on abilities of the agentic agents to accomplish assigned goals due to management decisions made by the user during the chat session; and
positioning the second representations with respect to the first representations to convey associations between the first representations and the second representations.
